(19) United States
(12) Patent Application Publication
(10) Pub. No.: US 2016/0104326 A1
(43) Pub. Date: Apr. 14, 2016

(54) ELECTRONIC DEVICE AND TOLL COLLECTION METHOD

(71) Applicant: Chiun Mai Communication Systems, Inc., New Taipei (TW)

(72) Inventor: CHIEN-YU LIN, New Taipei (TW)

(21) Appl. No.: 14/573,559

(22) Filed: Dec. 17, 2014

(30) Foreign Application Priority Data
Oct. 9, 2014 (CN) 201410529892.4

(51) Int. Cl. G07B 15/06; G06Q 20/32

(52) U.S. Cl. CPC G07B 15/063; G06Q 20/3224

(57) ABSTRACT

Method of paying a toll of a vehicle using an electronic device includes sending user information of the vehicle to a server, and requesting the server to allocate an identification code for paying the toll. When the identification code is received from the server, the identification code is encrypted using a preset encryption algorithm. Encrypted identification code is sent to the server, when a payment notice is received. The toll is deducted according to a preset toll collection rule from an account corresponding to a decrypted identification code, which is obtained by decrypting the encrypted identification code by the server.

### CROSS-REFERENCE TO RELATED APPLICATIONS

This application claims priority to Chinese Patent Application No. 201410529892.4 filed on Oct. 9, 2014, the contents of which are incorporated by reference herein.

### FIELD

The subject matter herein generally relates to charge technology, and particularly to an electronic device and a method for collecting tolls using the electronic device.

### BACKGROUND

A user of a vehicle may pay a toll using a personal account. The user needs to know when the toll is deducted from the account.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of one embodiment of a server in connection to an electronic device and a monitoring device.

FIG. 2 illustrates a diagrammatic view of one example of the monitoring device positioned on a trestle.

FIG. 3 illustrates a block diagram of one embodiment of function modules of a collecting system included in the server and the electronic device of FIG. 1.

FIG. 4 illustrates a flowchart of one embodiment of a method for paying a toll of a vehicle.

FIG. 5 illustrates a flowchart of one embodiment of a method for detecting the toll of the vehicle.

FIG. 6A illustrates one example of related information of the vehicle.

FIG. 6B illustrates one example of generating an identification code.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives.

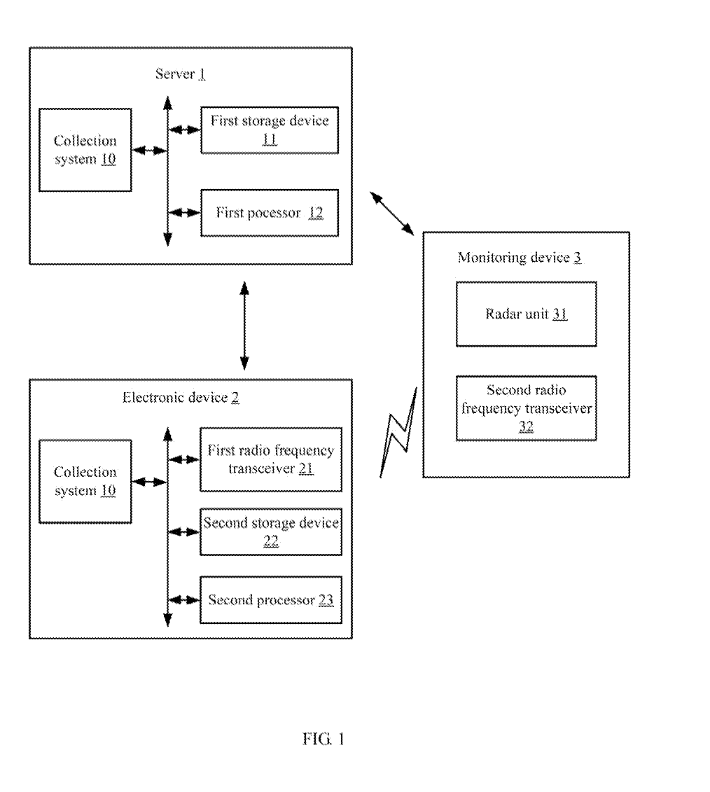

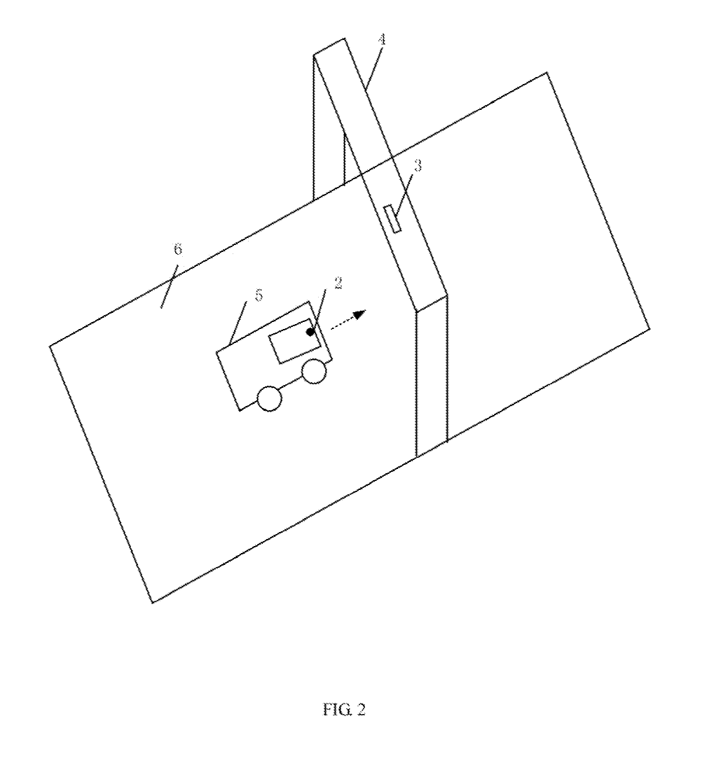

FIG. 1 illustrates a block diagram of one embodiment of a server in connection to an electronic device and a monitoring device. Depending on the embodiment, each of a server 1 and an electronic device 2 includes a collection system 10. As shown in FIG. 2, the electronic device 2 can be positioned in a vehicle 5. In one embodiment, the electronic device 2 can be a smart phone, a personal digital assistant (PDA), a tablet computer, or any other suitable electronic device. In one embodiment, the electronic device 2 is in connection to the server 1 using a General Packet Radio Service (GPRS) network.

The server 1 is wirelessly connected to a monitoring device 3. As shown in FIG. 2, the monitoring device 3 can be positioned on a trestle 4 of a highway 6. In one embodiment, the server 1 can use the collection system 10 to collect tolls of different vehicles (e.g., the vehicle 5) when the vehicles are detected by a radar unit 31 of the monitoring device 3.

In one embodiment, the server 1 further includes a first storage device 11 and a first processor 12. The electronic device 2 further includes a first radio frequency (RF) transceiver 21, a second storage device 22, and a second processor 23. The monitoring device 3 further includes a second RF transceiver 32. FIG. 1 illustrates only one example of the server 1, the electronic device 2 and the monitoring device 3. The server 1, the electronic device 2 and the monitoring device 3 can include more or fewer components than illustrated, or have a different configuration of the various components in other embodiments.

In one embodiment, the electronic device 2 can communicate with the monitoring device 3 using the first RF transceiver 21 and the second RF transceiver 32. The first storage device 11 and the second storage device 22 can be internal storage devices, such as flash memories, random access memories (RAM) for temporary storage of information, and/or read-only memories (ROM) for permanent storage of information. The first storage device 11 and the second storage device 22 can also be external storage devices, such as external hard disks, storage cards, or data storage mediums.

In one embodiment, the collection system 10 pre-stores related information of the vehicle 5 in the first storage device 11. In at least one embodiment, the related information includes, but is not limited to user information and account information of a user of the vehicle 5. The user information includes a user name and a corresponding password for paying the toll, and a license plate number of the vehicle 5. The account information includes a remaining balance of an account of the user.

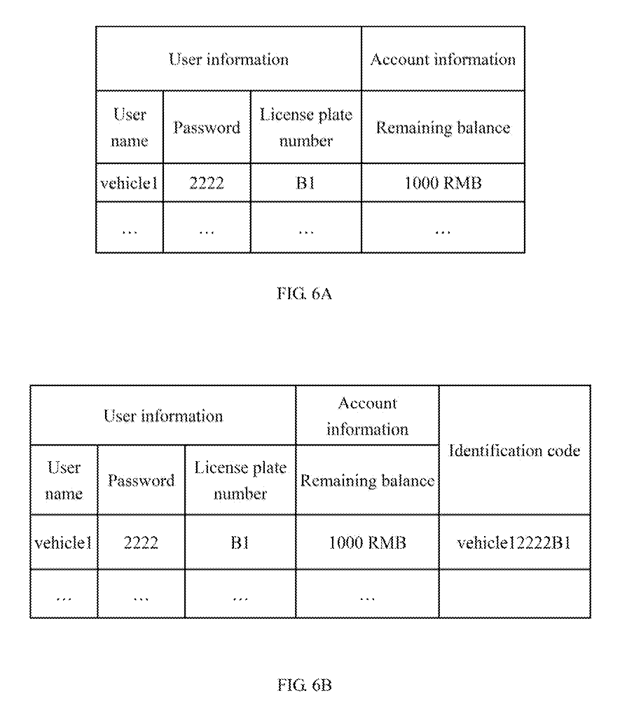

For example, as shown in FIG. 6A, the related information includes the user name “vehicle 1”, the corresponding password “2222” for paying the toll, the license plate number “B1” of the vehicle 5, and the remaining balance “1000 RMB” on the account.

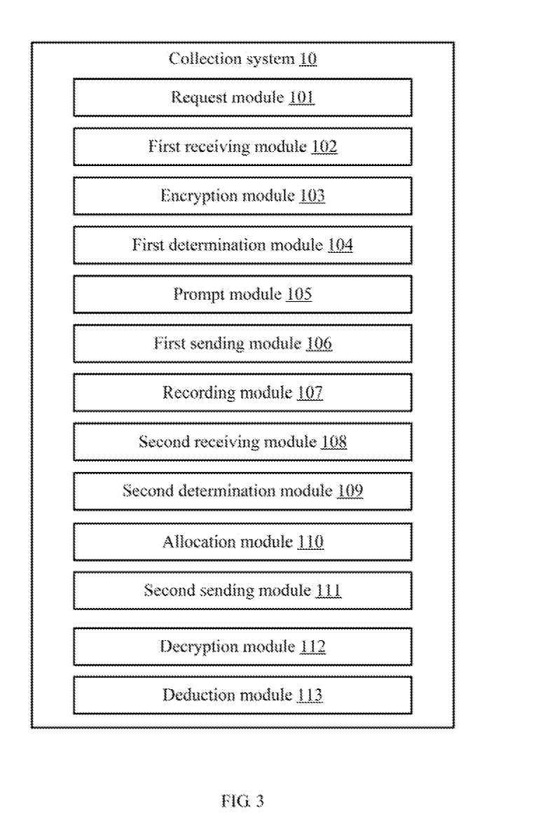

As shown in FIG. 3, the collection system 10 can include a request module 101, a first receiving module 102, an encryption module 103, a first determination module 104, a prompt module 105, a first sending module 106, a recording module 107, a second receiving module 108, a second determination module 109, an allocation module 110, a second sending module 111, a decryption module 112, and a deduction module 113.

The function modules 101-113 can include computerized codes in the form of one or more programs, which are stored in the first storage device 11 and the second storage device 22, and are executed by the first processor 12 and the second processor 23 to provide functions of the present disclosure.

In one embodiment, when the collection system 10 is executed in the electronic device 2, the second processor 22 executes the request module 101, the first receiving module 102, the encryption module 103, the first determination module 104, the prompt module 105, the first sending module 106, and the recording module 107. When the collection system 10 is executed in the server 1, the first processor 12 executes the second receiving module 108, the second determination module 109, the allocation module 110, the second sending module 111, the decryption module 112, and the deduction module 113. Details will be given in the following paragraphs.

The request module 101 in the electronic device 2 sends the user information of the vehicle 1 to the server 1, and requests the server 1 to allocate an identification code for paying the toll of the vehicle 5.

As mentioned above, the user information can include the user name, the corresponding password for paying the toll, and the license plate number of the vehicle 5. When the second receiving module 108 in the server 1 receives the user information, the second determination module 109 in the server 1 determines whether the user information matches preset user information stored in the first storage device 11. When the user information matches the preset user information, the allocation module 110 in the server 1 allocates the identification code for the vehicle 5. The second sending module 111 in the server 1 further sends the identification code to the electronic device 2, and saves the identification code in the first storage device 11.

In one embodiment, the allocation module 110 in the server 1 generates the identification code according to the user information. For example, as shown in FIG. 6B, an identification code “vehicle12222B1” is generated by sequentially combining a user name “vehicle1”, a corresponding password “2222”, and a license plate number “B1”. The second sending module 111 in the server 1 further sends the identification code “vehicle12222B1” to the electronic device 2, and saves the identification code “vehicle12222B1” in the first storage device 11.

The first receiving module 102 in the electronic device 2 receives the identification code from the server 1. For example, the first receiving module 102 in the electronic device 2 receives the identification code “vehicle12222B1” from the server 1.

The encryption module 103 in the electronic device 2 encrypts the identification code using a preset encryption algorithm and obtains an encrypted identification code. In one embodiment, the encryption algorithm is a cycle encryption algorithm.

The first receiving module 102 in the electronic device 2 receives a payment notice for paying the toll from the monitoring device 3. In one embodiment, when the vehicle 5 is near to the trestle 4, the vehicle 5 is detected by the radar unit 31 of the monitoring device 3. The monitoring device 3 sends the payment notice to the electronic device 2 through the second RF transceiver 32. Then the first receiving module 102 in the electronic device 2 receives the payment notice through the first RF transceiver 21.

The first determination module 104 in the electronic device 2 determines whether the electronic device 2 has obtained the encrypted identification code, when the payment notice is received. In some embodiments, the electronic device 2 has obtained the encrypted identification code when the payment notice is received. In other embodiments, the electronic device 2 has not obtained the encrypted identification code when the payment notice is received. For example, the collection system 10 is not booted until the vehicle 5 nearly passes through the trestle 4, thus, a result may be that the electronic device 2 has not obtained the encrypted identification code.

Under the condition that the electronic device 2 has not obtained the encrypted identification code when the payment notice is received, the prompt module 105 in the electronic device 2 prompts the user that the toll is not paid and a penalty may be generated.

In one embodiment, the first sending module 106 in the electronic device 2 sends the encrypted identification code to the server 1 via the monitoring device 3, when the electronic device 2 has already obtained the encrypted identification code. When the monitoring device 3 receives the encrypted identification code from the first sending module 106 in the electronic device 2, the monitoring device 3 forwards the encrypted identification code to the server 1.

In other embodiments, the first sending module 106 in the electronic device 2 sends the encrypted identification code to the server 1 directly, when the electronic device 2 has already obtained the encrypted identification code.

When the second receiving module 108 in the server 1 receives the encrypted identification code from the monitoring device 3 or from the first sending module 106 in the electronic device 2, the deduction module 113 in the server 1 deducts the toll according to a preset toll collection rule from the account of the user of the vehicle 5, when the encrypted identification code is received.

In one embodiment, the decryption module 112 in the server 1 decrypts the encrypted identification code using a preset decryption algorithm, and obtains a decrypted identification code. In some embodiments, the preset decryption algorithm can be an inverse algorithm of the encryption algorithm. The deduction module 113 in the server 1 deducts the toll according to the preset toll collection rule from the account corresponding to the decrypted identification code.

The second sending module 111 in the server 1 further sends the account information to the electronic device 2. In one embodiment, the account information includes an amount of the toll that is deducted from the account, the remaining balance of the account, deducted time when the toll is deducted from the account, and a location where the toll is deducted from the account.

The recoding module 107 in the electronic device 2 receives the account information from the server 1, and saves the account information in the second storage device 22.

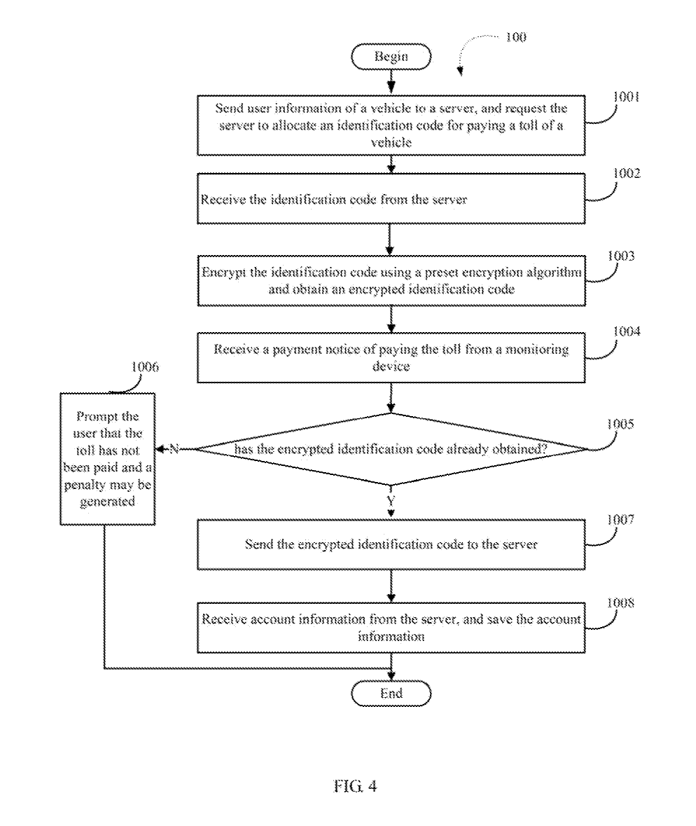

FIG. 4 illustrates a flowchart of an example embodiment of a method for paying a toll of a vehicle using an electronic device. In the example embodiment, the method is performed by execution of computer-readable software program codes or instructions by the second processor of the electronic device. The method can automatically pay the toll of the vehicle.

Referring to FIG. 4, a flowchart is presented in accordance with an example embodiment which is being thus illustrated. In the embodiment, the example method 100 is provided by way of example only as there are a variety of ways to carry out the method. The method 100 described below can be carried out using the configurations illustrated in FIG. 1, for example, and various elements of these figures are referenced in explaining the example method 100. Each block shown in FIG. 4 represents one or more processes, methods or subroutines, carried out in the exemplary method 100. Furthermore, the illustrated order of blocks is by example only and the order of the blocks can be changed according to the present disclosure. Additional blocks may be added or fewer blocks may be utilized, without departing from this disclosure. The exemplary method 100 can begin at block 1001.

At block 1001, a request module sends user information of a vehicle to a server, and requests the server to allocate an identification code for paying a toll of a vehicle.

In the embodiment, the user information can include a user name, a corresponding password for paying the toll, and a license plate number of the vehicle. When the server receives the user information, the server determines whether the user information matches preset user information. When the user information matches the preset user information, the server allocates the identification code. The server further sends the identification code to an electronic device that is positioned in the vehicle, and saves the identification code in a first storage device.

In the embodiment, the server generates the identification code according to the user information. For example, as shown in FIG. 6B, an identification code “vehicle12222B1” is generated by sequentially combining a user name “vehicle1”, a corresponding password “2222”, and a license plate number “B1”.

At block 1002, a first receiving module receives the identification code from the server. For example, the first receiving module receives the identification code “vehicle12222B1” from the server.

At block 1003, an encryption module encrypts the identification code using a preset encryption algorithm and obtains an encrypted identification code. In the embodiment, the encryption algorithm is a cycle encryption algorithm.

At block 1004, the first receiving module receives a payment notice of paying the toll from a monitoring device. In the embodiment, when the vehicle is near to a trestle of a highway, the vehicle is detected by a radar unit of the monitoring device that is positioned on the trestle. The monitoring device sends a payment notice to the electronic device through a second radio frequency (RF) transceiver. Then the first receiving module receives the payment notice through a first RF transceiver of the electronic device.

At block 1005, a first determination module determines whether the electronic device has obtained the encrypted identification code, when the payment notice is received. In some embodiments, the electronic device has obtained the encrypted identification code when the payment notice is received. In other embodiments, the electronic device has not obtained the encrypted identification code when the payment notice is received. For example, the electronic device 2 is not booted until that the vehicle 5 nearly passes through the trestle 4, thus, it may be result that the electronic device 2 has not obtained the encrypted identification code.

When the electronic device has not obtained the encrypted identification code, the process goes to block 1006. When the electronic device has obtained the encrypted identification code, the process goes to block 1007.

At block 1006, a prompt module prompts the user that the toll has not been paid and may result a penalty, when the electronic device has not obtained the encrypted identification code.

At block 1007, in one embodiment, a first sending module sends the encrypted identification code to the server via the monitoring device, when the electronic device has already obtained the encrypted identification code. When the monitoring device receives the encrypted identification code from the first sending module, the monitoring device forwards the encrypted identification code to the server. In other embodiments, the first sending module sends the encrypted identification code to the server directly.

The server deducts the toll according to a preset toll collection rule from an account of a user of the vehicle, when the encrypted identification code is received. In one embodiment, when the server receives the encrypted identification code, the server decrypts the encrypted identification code using a preset decryption algorithm, and obtains a decrypted identification code. The server further deducts the toll according to the preset toll collection rule from the account corresponding to the decrypted identification code. The preset decryption algorithm is an inverse algorithm of the encryption algorithm.

The server further sends the account information to the electronic device. In one embodiment, the account information includes an amount of the toll that is deducted from the account, a remaining balance of the account, deducted time when the toll is deducted from the account, and a location where the toll is deducted from the account.

At block 1008, a recoding module receives the account information from the server, and saves the account information in a second storage device.

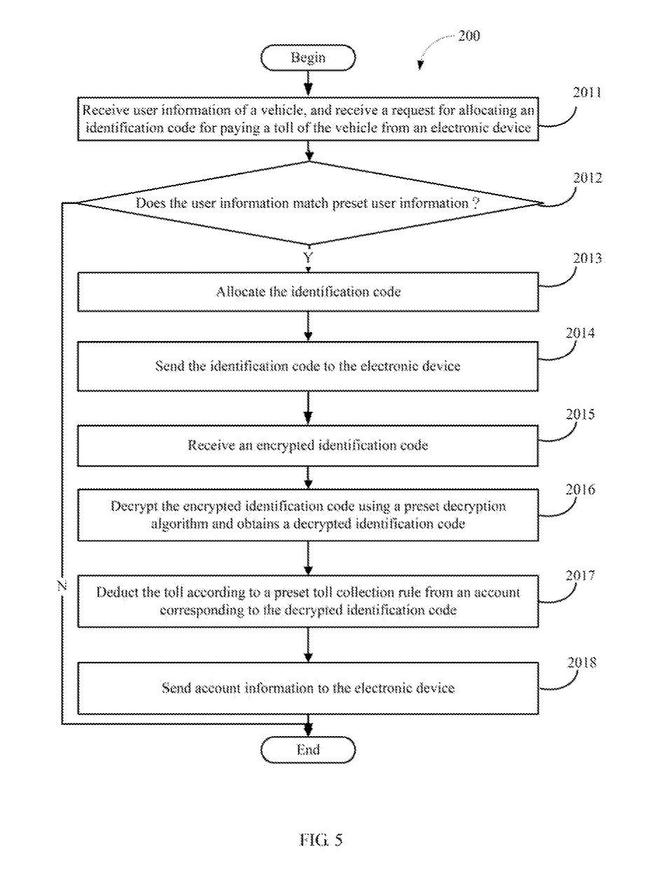

FIG. 5 illustrates a flowchart of an example embodiment of a method for deducting a toll of a vehicle using a server. In the example embodiment, the method is performed by execution of computer-readable software program codes or instructions by the first processor of the server. The method can automatically deduct the toll of the vehicle.

Referring to FIG. 5, a flowchart is presented in accordance with an example embodiment which is being thus illustrated. In the embodiment, the example method 200 is provided by way of example only as there are a variety of ways to carry out the method. The method 200 described below can be carried out using the configurations illustrated in FIG. 1, for example, and various elements of these figures are referenced in explaining the example method 200. Each block shown in FIG. 5 represents one or more processes, methods or subroutines, carried out in the exemplary method 200. Furthermore, the illustrated order of blocks is by example only and the order of the blocks can be changed according to the present disclosure. Additional blocks may be added or fewer blocks may be utilized, without departing from this disclosure. The exemplary method 200 can begin at block 2011.

At block 2011, a second receiving module receives user information of a vehicle, and receives a request for allocating an identification code for paying a toll of the vehicle, from an electronic device. In one embodiment, the user information can include the user name, the corresponding password for paying the toll, and the license plate number of the vehicle.

At block 2012, a second determination module determines whether the user information matches preset user information stored in a first storage device of the server. When the user information matches the preset user information, the process goes to block 2013. When the user information does not match the preset user information, the process is end.

At block 2013, an allocation module allocates the identification code for the vehicle, when the user information matches the preset user information. The allocation module further saves the identification code in the first storage device. In the embodiment, the allocation module generates the identification code according to the user information. For example, as shown in FIG. 6B, an identification code “vehicle12222B1” is generated by sequentially combining a user name “vehicle1”, a corresponding password “2222”, and a license plate number “B1”. The server further saves the identification code “vehicle12222B1” in a first storage device.

At block 2014, a second sending module sends the identification code to the electronic device. For example, the second sending module sends the identification code “vehicle12222B1” to the electronic device

At block 2015, in one embodiment, the second receiving module receives an encrypted identification code from a monitoring device. In other embodiments, the second receiving module receives the encrypted identification code from the electronic device directly.

In one embodiment, when the vehicle is near a trestle of a highway, the vehicle is detected by a radar unit of the monitoring device, which is positioned on the trestle. Then the monitoring device sends the payment notice to the electronic device through a second radiofrequency (RF) transceiver. The electronic device receives the payment notice through a first RF transceiver of the electronic device, and sends the encrypted identification code to the monitoring device. The monitoring device forwards the encrypted identification code to the server.

At block 2016, a decryption module decrypts the encrypted identification code using a preset decryption algorithm and obtains a decrypted identification code.

At block 2017, a deduction module deducts the toll according to a preset toll collection rule, from an account corresponding to the decrypted identification code.

At block 2018, a second sending module sends account information to the electronic device. In one embodiment, the account information includes an amount of the toll that is deducted from the account, a remaining balance of the account, deducted time when the toll is deducted from the account, and a location where the toll is deducted from the account. In one embodiment, the second sending module further sends a warning notice to the electronic device when the remaining balance of the account is smaller than a preset value.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for paying a toll of a vehicle using an electronic device that is positioned in the vehicle, the electronic device comprising at least one processor, the method comprising:
sending user information of the vehicle to a server, the server allocating an identification code corresponding to a user associated with the vehicle;
receiving the identification code from the server;
encrypting, using the at least one processor, the identification code using a preset encryption algorithm and obtaining an encrypted identification code;
receiving a payment notice of paying the toll from a monitoring device that is in communication with the server; and
sending the encrypted identification code to the server, the server deducting the toll according to a preset toll collection rule from an account of the user.

2. The method according to claim 1, wherein the server deducts the toll by:
decrypting the encrypted identification code using a preset decryption algorithm, when the encrypted identification code is received;
obtaining a decrypted identification code; and
deducting the toll according to the preset toll collection rule from the account of the user of the vehicle, the account corresponding to the decrypted identification code.

3. The method according to claim 2, wherein the encrypted identification code is received from the monitoring device.

4. The method according to claim 1, wherein the monitoring device sends the payment notice to the electronic device when the vehicle is detected by a radar unit of the monitoring device.

5. The method according to claim 1, further comprising:
receiving account information from the server, and saving the account information, the account information comprising an amount of the toll that is deducted from the account, a remaining balance of the account, deducted time when the toll is deducted from the account, and a location where the toll is deducted from the account.

6. A computer-implemented method for collecting a toll of a vehicle using a server, the server comprising at least one processor, the method comprising:
receiving, from an electronic device that is positioned in the vehicle, an encrypted identification code, or receiving the encrypted identification code from a monitoring device that is in communication with the server;
decrypting the encrypted identification code using a preset decryption algorithm and obtaining a decrypted identification code; and
deducting the toll according to a preset toll collection rule, from an account corresponding to the decrypted identification code.

7. The method according to claim 6, further comprising:
receiving, from the electronic device, user information of the vehicle and a request for allocating an identification code for paying the toll;
allocating the identification code when the user information matches preset user information; and
sending the identification code to the electronic device.

8. The method according to claim 6, further comprising:
sending account information to the electronic device, the account information comprising an amount of the toll that is deducted from the account, a remaining balance of the account, deducted time when the toll is deducted from the account, and a location where the toll is deducted from the account.

9. The method according to claim 8, further comprising:
sending a warning notice to the electronic device when the remaining balance of the account is smaller than a preset value.

10. An electronic device that is positioned in a vehicle, comprising:
at least one processor; and
a storage device that stores one or more programs, when executed by the at least one processor, cause the at least one processor to:
send user information of the vehicle to a server, the server allocating an identification code corresponding to a user associated with the vehicle;
receive the identification code from the server;
encrypt, using the at least one processor, the identification code using a preset encryption algorithm and obtain an encrypted identification code;
receive a payment notice of paying the toll from a monitoring device that is in communication with the server; and
send the encrypted identification code to the server, the server deducting the toll according to a preset toll collection rule from an account of the user.

11. The electronic device according to claim 10, wherein the server deducts the toll by:
decrypting the encrypted identification code using a preset decryption algorithm, when the encrypted identification code is received;
obtaining a decrypted identification code; and
deducting the toll according to the preset toll collection rule from the account of the user of the vehicle, the account corresponding to the decrypted identification code.

12. The electronic device according to claim 11, wherein the encrypted identification code is received from the monitoring device.

13. The electronic device according to claim 10, wherein the monitoring device sends the payment notice to the electronic device when the vehicle is detected by a radar unit of the monitoring device.

14. The electronic device according to claim 10, wherein the processor further:
receiving account information from the server, and saving the account information, the account information comprising an amount of the toll that is deducted from the account, a remaining balance of the account, deducted time when the toll is deducted from the account, and a location where the toll is deducted from the account.
